(19) United States
(12) Patent Application Publication
(10) Pub. No.: US 2018/0163392 A1
(43) Pub. Date: Jun. 14, 2018

(54) APPARATUS AND METHOD FOR CODING OF AN ANCHOR POINT IN A STRUCTURE

(71) Applicant: Hilti Aktiengesellschaft, Schaan (LI)

(72) Inventors: Matteo SPAMPATTI, Addison, TX (US); Joshua James BARHITTE, Buchs (CH); Alok Gautam THAKUR, Buchs (CH)

(73) Assignee: Hilti Aktiengesellschaft, Schaan (LI)

(21) Appl. No.: 15/374,309

(22) Filed: Dec. 9, 2016

(51) Int. Cl. E04B 1/41; G09F 23/00

(52) U.S. Cl. CPC E04B 1/41; G09F 23/00

(57) ABSTRACT

An apparatus for coding of an anchor point is disclosed. The apparatus includes a single point anchor and a coded element associated with the single point anchor. The coded element includes an indicia that is indicative of a use of the single point anchor with a function. A method for coding of an anchor point in a structure is also disclosed. The method includes associating a coded element with a single point anchor, where the coded element includes an indicia that is indicative of a use of the single point anchor with a function. The single point anchor and the coded element are disposed in the structure.

### BACKGROUND OF THE INVENTION

Single point cast-in anchors are known. A single point cast-in anchor is a pre-installed anchor that is provided to connect a male element, e.g., a threaded rod, bolt, etc., or a female element, e.g., a connector, to a concrete structure, such as a ceiling or a floor. Typical applications are grouped into the mechanical, electrical, and plumbing installations in, for example, a building. More specifically, single point cast-in anchors are typically used for fastening:
water pipes;
sprinklers;
heating, ventilation, and air conditioning (HVAC) elements;
electrical pipes;
cable trays and conduits;
mechanical elements; and
more-generally, nonstructural elements to a soffit.

The key advantages of this type of anchor versus any other type of anchor, such as studs or chemical anchors, are easiness to design/specify, ease of installation, reliability, relatively low cost, and limited inspection is required after installation.

A single point cast-in anchor is installed as follows:
step 1: position/locate the anchor, e.g., to avoid other installations in the concrete;
step 2: install the anchors in a wood form, e.g., by hammering the anchors in the wood form with nails or by using an installation tool;
step 3: pouring the concrete;
step 4: removing the wood form;
step 5: breaking the portion of the nails extending from the concrete, if used; and
step 6: fastening the female or the male connection to the anchor.

Such anchors are available in various sizes, with all of the various sizes being able to fasten a single threaded rod. The anchors are generally composed of a metal body, i.e., the anchor itself, and a plastic sleeve which holds nails in place, which nails then hold the anchor in position on the wood form when attaching the anchor to the wood form. The anchors generally have a non-circularly shaped head, to prevent the anchor from spinning when disposed in the poured concrete.

Because the anchors may be of various sizes to fasten differently sized threaded rods, the anchors may be color coded where a different color is associated with each different size anchor. This color coding may be effected by color coding the plastic sleeve where, for example, a red sleeve may be used for a ⅜ inch anchor.

However, on any particular job site, it is common to use several hundred, or even thousands, of single point cast-in anchors at a time, which are meant to be used to fasten the various different elements, e.g., pipes, sprinklers, HVAC elements, etc., of the different trades and of the different contractors that are installing the different types of elements. For example, the plumbers will use some of the installed anchors and the fire protection contractors will also use some of the installed anchors. Hence, a problem exists with identifying which of the installed anchors are to be used by which of the various contractors for the various systems, e.g., plumbing, electrical, etc.

Whereas the various sizes of the anchors may be determined, it is very difficult to identify the anchors that are to be used for the various purposes. Hence, once the wood form is removed, it is possible to identify the anchors and their sizes, but not the application for which they were installed. Thus, it is difficult to identify which anchor belongs to which application, which results in wasted time since the contractors must find and review the overall anchor layout plans. It is also difficult to identify which anchor belongs to which contractor. Further, possible errors can result since contractors can use anchors that are meant to be used by other contractors for other applications. This can result in possibly the need to install other anchors, or in a worst case scenario, require a total re-do of the layout of the anchors.

It has been known to spray paint the anchors with different colors before installation. Or, the anchor location can be spray painted on the wood form before the concrete is poured, and thus, possibly some of the spray paint from the wood form can be transferred to the concrete. However, both of these spray painting methods are inefficient for a variety of reasons including being time-intensive, unreliable, and potentially covering the thread-size color coding of the anchor.

Thus, a need is present to facilitate the identification of single point cast-in anchors, once the anchors are installed. This will reduce the time required to identify the anchors to be used so that there is no need to look at the master plan every time. This will also reduce errors from occurring where one contractor is using the fastening point of another contractor. Further, this will reduce the requirement for any redesign of the anchor layouts in the case of error and reduce the use of post-installed anchors, which will also save time and costs.

### SUMMARY OF THE INVENTION

An apparatus for coding of an anchor point includes a single point anchor and a coded element associated with the single point anchor. The coded element includes an indicia that is indicative of a use of the single point anchor with a function.

A method for coding of an anchor point in a structure includes the steps of associating a coded element with a single point anchor, where the coded element includes an indicia that is indicative of a use of the single point anchor with a function. The single point anchor and the coded element are disposed in the structure.

### BRIEF DESCRIPTION OF THE DRAWINGS

FIG. 1 illustrates an anchor apparatus in accordance with the principles of the present invention in association with a concrete structure and a wood form;

FIG. 2A is a perspective view of another embodiment of an anchor apparatus of the present invention;

FIG. 2B is a bottom view of the anchor apparatus of FIG. 2A;

FIG. 2C is a side view of the anchor apparatus of FIG. 2A;

FIGS. 3A-3C illustrate the embodiment of the color-coded element of FIGS. 2A-2C;

FIGS. 4A-4C illustrate an alternative embodiment of a color-coded element;

FIGS. 5A-5C illustrate a further embodiment of a color-coded element;

FIGS. 6A-6C illustrate a further embodiment of a color-coded element;

FIGS. 7A-7C illustrate a further embodiment of a color-coded clement;

FIGS. 8A-8C illustrate a further embodiment of a color-coded element;

FIGS. 9A-9C illustrate an embodiment of the color-coded element as also shown in FIG. 1;

FIGS. 10A-10C illustrate a further embodiment of a color-coded clement;

FIGS. 11A-11C illustrate a further embodiment of a color-coded element;

FIGS. 12A-12D illustrate a further embodiment of a color-coded element as used with a sleeve of the anchor apparatus;

FIGS. 13A-13C illustrate a further embodiment of a color-coded element as used with a sleeve of the anchor apparatus;

FIGS. 14A-14B further illustrate the embodiment of the color-coded element of FIGS. 13A-13C;

FIGS. 15A-15C illustrate a further embodiment of a color-coded element as used with a sleeve of the anchor apparatus;

FIG. 15D illustrates an embodiment of a coded element where the indicia is a graphic;

FIG. 15E illustrates an embodiment of a coded element where the indicia is text;

FIGS. 16A-16B further illustrate the embodiment of the color-coded element of FIGS. 15A-15C; and

FIG. 17 illustrates an embodiment of the anchor apparatus with an additional color-coded element.

### DETAILED DESCRIPTION OF THE DRAWINGS

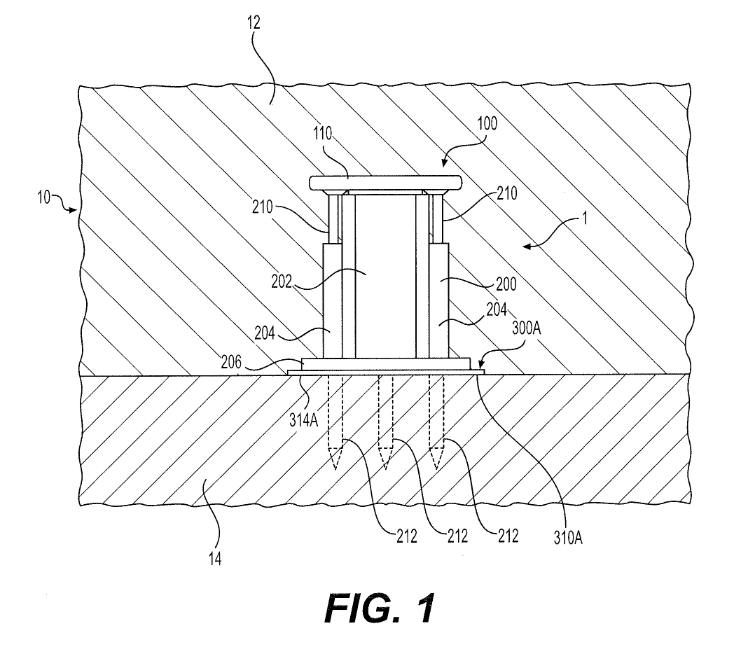

FIG. 1 illustrates the anchor apparatus 1 of the present invention in association with a building structure 10 where the building structure includes a concrete structure 12 and a wood form 14. The anchor apparatus 1 includes a single point anchor 100, a sleeve 200 with nails 210, and a color-coded element 300A. As can been seen, during the installation process of the anchor apparatus 1, the single point anchor 100 and sleeve 200 become cast into the concrete structure 12 when the concrete is poured to form the concrete structure. Also during the installation process, the color-coded element 300A becomes disposed between the concrete structure 12 and the wood form 14, and then when the wood form 14 is removed, the color-coded element 300A is partially disposed in the concrete structure 12 such that at least a lowest-most surface 310A of the color-coded element 300A is visible. The portion 212 of the nails 210 that extend below the surface of the concrete structure are removed from the nails 210 by, for example, breaking the portions 212 off by striking them with a hammer.

As can be seen, the sleeve 200 is disposed around the single point anchor 100. Thus, the single point anchor 100 has a cylindrical body with an internal cavity that is able to receive a threaded connector within the cavity. The threaded connector is associated with a structure that is to be mounted on the concrete structure 12. Thus, the anchor 100 is a single point anchor 100 since a single threaded connector, and thus a single structure, is mounted on the single point anchor.

The sleeve 200 also has a central cylindrical body 202 that surrounds the cylindrical body of the single point anchor 100. The cylindrical body of the single point anchor 100 is axially movable within the central cylindrical body 202 of the sleeve.

The sleeve 200 also includes tubular structures 204 which are disposed on the outside of the cylindrical body 202 and which each receive one of the nails 210. In an embodiment, three nails 210, and accordingly, three tubular structures 204 are provided. The nails 210 and tubular structures 204 are spaced evenly around the single point anchor 100, and thus, are spaced 120° from each other around the circumference of the single point anchor 100 and sleeve 200. The tubular structures 204 are designed to hold the nails 210. Sleeve 200 also includes a base plate 206 that engages with a base plate 314A of color-coded element 300A.

The top of the single point anchor 100 has a striking surface 110 that can be struck by a hammer to drive the nails 210 into the wood form 14. This striking surface may be the head of the single point anchor and the head may be hexagonally shaped to prevent the single point anchor from spinning in the concrete structure 12 when a threaded connector is threaded into the single point anchor. The nails 210 are axially movable within the tubular structures 204 such that they are able to be driven into the wood form 14 when a hammer strikes the striking surface 110. When the hammer strikes the striking surface 110, the cylindrical body of the single point anchor 100 axially moves through cylindrical body 202 of the sleeve and the striking surface accordingly drives the nails 210 axially through the tubular structures 204 to drive the portion 212 of the nails 210 into the wood form 14. In an alternative embodiment, the single point anchor, the sleeve, and nails can be rigidly connected together such that all these components are driven together into the wood form with the hammer strikes.

Whereas an embodiment of the anchor apparatus includes a sleeve and nails, such sleeve and nails are not required. The sleeve and nails assist in positioning and securing the single point anchor on the wood form. However, the sleeve and nails are not required for such positioning and securing. The single point anchor and color-coded element could be placed on the wood form without a sleeve and nails, and possibly be attached to the wood form by other means, e.g., an adhesive.

As discussed above, the color-coded element 300A is disposed at a bottom-most portion of the single point anchor 100, and the sleeve 200 if used, and is assembled to the single point anchor 100 and the sleeve 200. After the wood form 14 is removed, the lowest-most surface 310A of the color-coded element 300A is visible. Thus, a color-coded element 300A is disposed between the single point anchor 100 and the wood form 14 before the wood form 14 is removed. In the embodiment of FIG. 1, the color-coded element 300A is a flat disk.

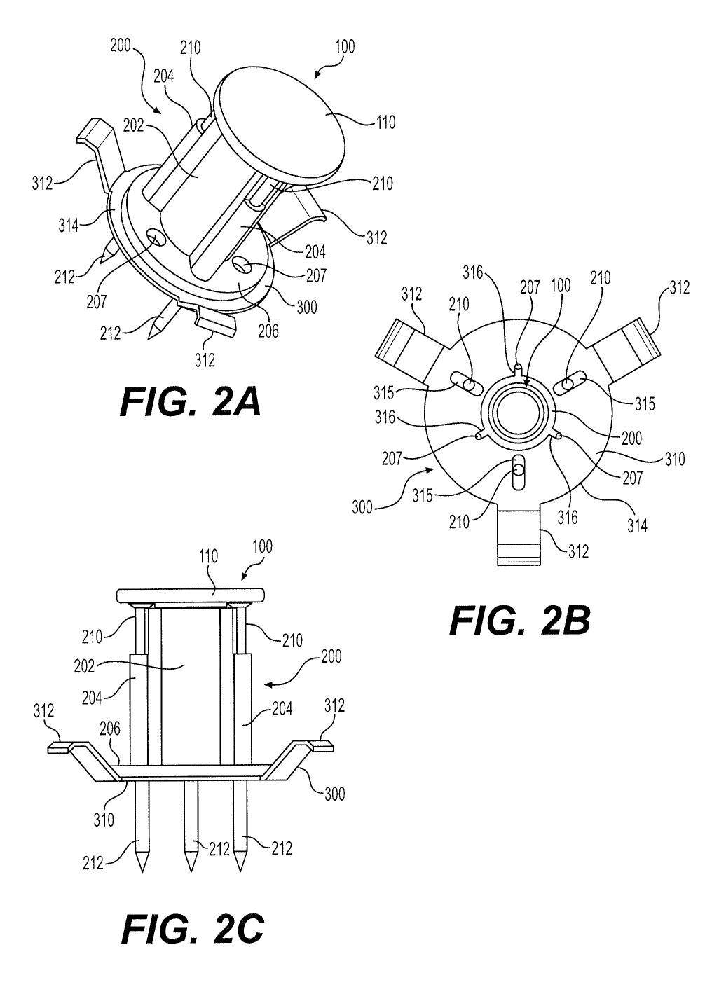

In the embodiment of the color-coded element 300 of FIGS. 2A-2C, the color-coded element 300 has three wings 312 that are spaced 120° from each other around the circumference of the color-coded element 300. Wings 312 extend from an outer circumference of base plate 314 and upwardly from base plate 314 toward a head of the single point anchor, e.g., the striking surface 110. When the concrete is poured to form concrete structure 12, the wings 312 become disposed within the concrete structure to secure the color-coded element 300 to the concrete structure 12.

As can be further seen in FIG. 2B, which is a view of the bottom of anchor apparatus, slots 315 are provided in the base plate 314 of color-coded element 300. The slots 315 each receive one of the nails 210 through it such that the nails 210 can pass through the color-coded element 300. The slot-shape of the slots 315 provides for margin in positioning the nails 210 with respect to the color-coded element 300. Further, the slots will be designed in such a way that they will create an engagement with the nails such that, once the color-coded element is installed in the apparatus, it will not easily come off. Therefore, the diameter of the nails is greater than or equal to the width of the slots.

The present invention is not limited to three slots or three nails. Any number of slots and nails, and corresponding tubular structures on the sleeve, can be contemplated in the present invention depending on the particular installation requirements.

As can be further seen, the base plate 206 may include apertures 207. As can be particularly seen in the bottom view of FIG. 2B, the apertures 207 of base plate 206 of sleeve 200 can align with radial cuts 316 in color-coded element 300 that extend from the aperture of the color-coded element. These aligned apertures 207 and radial cuts 316 provide for receiving respective structures for further securing/positioning of the anchor apparatus to the wood form 14, however, such structures are not required. Further, the radial cuts can provide for threaded connectors that are larger than the diameter of the central aperture in the base plate 314 of color-coded element 300 being received through the central aperture. The radial cuts provide flexibility in the base plate for expanding the central aperture when a threaded connector with a larger diameter than the aperture is inserted through the aperture.

Further details of embodiments of the color-coded element will be discussed in connection with the drawings showing the different embodiments.

As can be seen, and as discussed, the color-coded element is associated with the single point anchor 100. The color-coded element includes a color, e.g., is colored, such that the color is indicative of a use of the single point anchor 100 with a function. The function may be, for example, an electrical system or a plumbing system or a mechanical system. Thus, for example, if the single point anchor 100 is to be used to mount a plumbing fixture to the single point anchor 100, the color-coded element that is associated with that single point anchor 100 can be colored, for example, with a purple color where the purple color is indicative of the use of that single point anchor for a plumbing function, and thus, a plumbing fixture such as a plumbing drain line. Similarly, all other single point anchors in a building plan layout that are also to be used for the plumbing function would also have associated, purple colored, color-coded elements. In this way, all of the single point anchors that are assigned for the plumbing function can be similarly colored, and thus, easily identified by the plumbing contractor.

In like manner, a color-coded element can include another color that is indicative of another use of another single point anchor with another function. For example, a fresh water function, e.g., drinking water, can use the color blue. A fire sprinkler function can use the color red. An electrical function can use the color yellow. The present invention is not limited to any particular color with any particular function or to any number of colors and functions.

Further, other information can be included on the color-coded element. For example, specific information related to the contractor that is responsible for the identified functions, e.g., the company name or logo of the contractor, can be included on the color-coded element. Additionally, other specific information, e.g., free text, can be provided on the color-coded element to provide further helpful information for the installer and/or contractor.

As discussed previously, the sleeve 200 can be color-coded to indicate the size of the single point anchor 100 that is associated with the sleeve, and thus, the size of the threaded connector that can be received within the single point anchor 100. As such, the sleeve 200 can also include a color where this color is indicative of a size of the single point anchor 100. For example, a blue colored sleeve could indicate a ½ inch single point anchor 100 and threaded connector. A red colored sleeve could indicate a ¾ inch single point anchor 100 and threaded connector. The present invention is also not limited to any particular color with any particular size or to any number of colors and sizes.

Further, the same color can be used for both the color-coded element and sleeve 200 that are associated with the same single point anchor 100. Because the colors are on different components, i.e., the color-coded element and the sleeve 200, the same color can designate different parameters for the different components. For example, for the same single point anchor 100, both the color-coded element and the sleeve 200 that are associated with that single point anchor 100 can be colored purple. The purple color-coded element could indicate the plumbing function and the purple sleeve 200 could indicate a ¼ inch single point anchor and threaded connector.

Additionally, the present invention is not limited to how the color-coded element, and the sleeve 200, is color coded. These elements can be totally colored in these colors or any form of color swatch can be applied to these elements.

As can be seen particularly in the bottom view of the anchor apparatus of FIG. 2B, because an aperture in the color-coded element 300 has a larger diameter than an axially aligned aperture of the sleeve 200, a portion of the sleeve 200 can still be seen when looking up at the bottom of the anchor apparatus. Therefore, both the color coding of the color-coded element 300 and the color coding of the sleeve 200 can be seen even after the anchor apparatus is installed in the concrete structure 12.

As can also been seen in the bottom view of FIG. 2B, the aperture of the color-coded element 300 also axially aligns with the internal cavity of the cylindrical body of the single point anchor 100 which receives within it the threaded connector.

Whereas the embodiment disclosed thus far describes a color-coded element, the present invention is not limited to an element that is color coded, and thus, a color-coded element. More broadly, the element is a coded element that can include any of a variety of codes for indicating a use of the single point anchor with a function. As such, the element is a coded element that includes an indicia that is indicative of a use of the single point anchor with a function. As discussed above, the indicia can be a color where the color indicates the use of the single point anchor with a function. Alternatively, the indicia can be a graphic, e.g., picture, logo, drawing, etc., or text, e.g., letter(s), word(s), etc., that indicates the use of the single point anchor with a function.

Further yet, the present invention is not limited to the indicia being only a single color that indicates the use of the single point anchor with a function. For example, the indicia can include the multiple colors of a rainbow for indicating the use of the single point anchor with a function.

However, as discussed above where the present invention only requires a coded element with an indicia that indicates the use of the single point anchor with a function, hereinafter the further embodiments will again be discussed in the context of a color-coded element. Of course, these further embodiments, and all embodiments, of the color-coded element apply equally to the coded element with an indicia of the present invention.

As with the coded element, the sleeve is also not limited to being color-coded. Thus, the sleeve can also include an indicia that indicates, for example, the size of the single point anchor that is associated with the sleeve, and thus, the size of the threaded connector that can be received within the single point anchor, or any other characteristic of the single point anchor or sleeve, e.g., the material of the single point anchor, length of the single point anchor, etc.

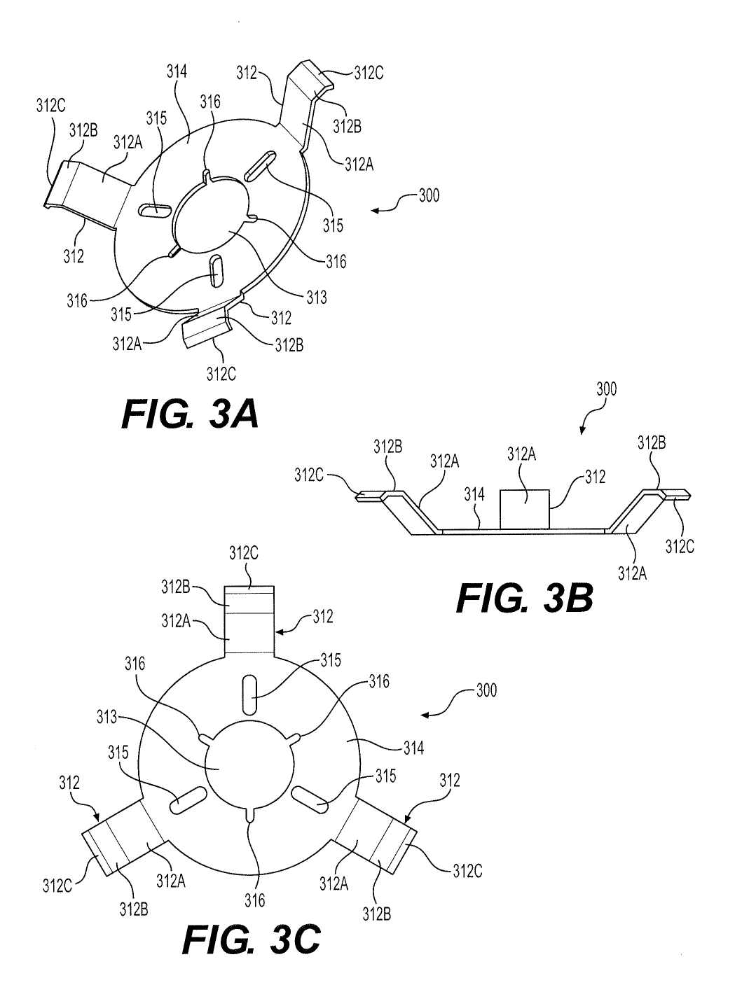

Continuing, FIGS. 3A-3C further illustrate the embodiment of the color-coded element of FIGS. 2A-2C. FIG. 3A is a perspective view, FIG. 3B is a side view, and FIG. 3C is a bottom view. As can be seen, and as discussed above, in this embodiment of the color-coded element 300, the color-coded element 300 has three wings 312 that are spaced 120° from each other around the circumference of the color-coded element 300. Wings 312 extend from an outer circumference of base plate 314 and upwardly from base plate 314.

Each of the wings 312 includes a generally upward extending portion 312A which extends generally upwardly from base plate 314, i.e., at an angle of 45° plus/minus several degrees. Extending generally flat from the upward extending portion 312A, i.e., at an angle of approximately 45° plus/minus several degrees with respect to upward extending portion 312A, and generally parallel to base plate 314, is a flat portion 312B. Further, extending generally downwardly from the flat portion 312B is downward extending portion 312C. Downward extending portion 3120 extends generally downwardly from flat portion 312B, i.e., at an angle of 45° plus/minus several degrees with respect to flat portion 312B. Upward extending portion 312A and downward extending portion 312C extend at generally the same angle with respect to flat portion 312B. In this embodiment, the upward extending portion 312A and downward extending portion 312C have different lengths. Thus, the downward extending portion 312C extends a much shorter distance than upward extending portion 312A.

As can be understood, the general hook-shape of the wings 312 permits the wings 312 to be securely embedded within the concrete structure 12 and to resist a downwardly exerted force that would tend to pull the wings 312, and thus, the color-coded element 300 downwardly and out of the concrete structure 12. Thus, the wings create an undercut in the concrete structure. As discussed, this undercut provides for the color-coded element to securely stay in the concrete structure 12 once the wood form 14 is removed and nails 210 are broken off.

As was discussed above, slots 315 are provided in the base plate 314 of color-coded element 300 and radial cuts 316 extend from the aperture 313 of the color-coded element 300.

The color-coded element may be made out of a thin, colored plastic material, such as polypropylene or polyethylene. However, it may also be made . from a carbon or steel material. It may, be produced by a plastic molding technique or any of a variety of other production methods. The color-coded element may also be used as a seal to protect the concrete structure 12 from intrusion by liquids, or even solids.

The following Figures illustrate various other alternative embodiments for the color-coded element. In the Figures for the various embodiments, generally only the differences in the embodiments will be discussed.

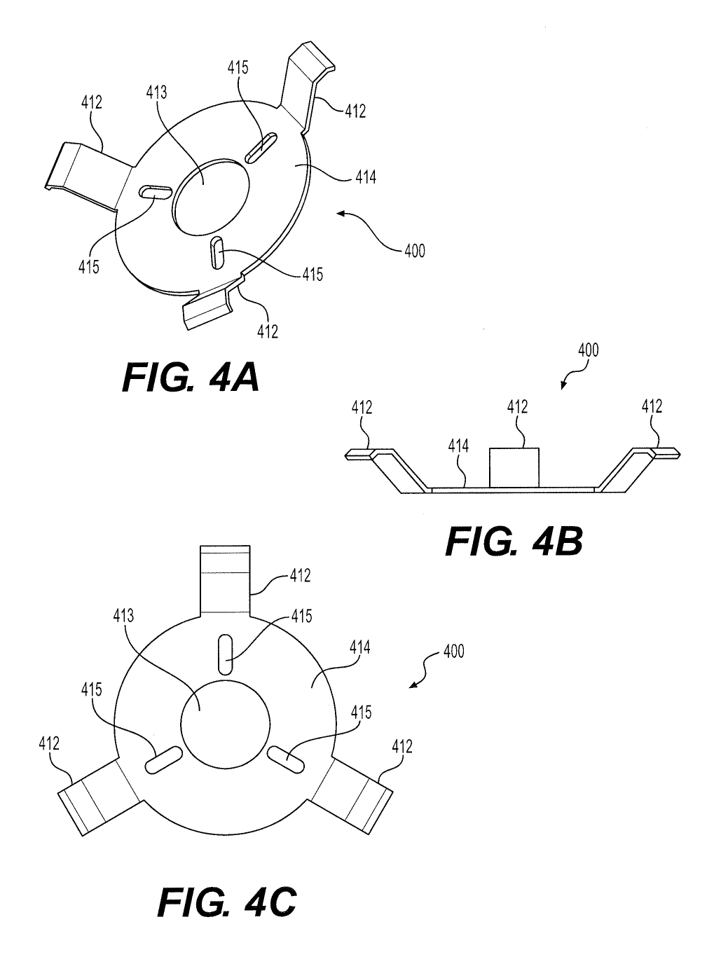

FIGS. 4A-4C illustrate another embodiment of a color-coded element. FIG. 4A is a perspective view, FIG. 4B is a side view, and FIG. 4C is a bottom view. As can be seen, this embodiment of color-coded element 400 also has three wings 412, formed similarly to wings 312 of color-coded element 300. The color-coded element 400 also has three slots 415 provided in the base plate 414. However, this embodiment of color-coded element 400 does not have radial cuts that extend from the aperture 413 of the color-coded element 400.

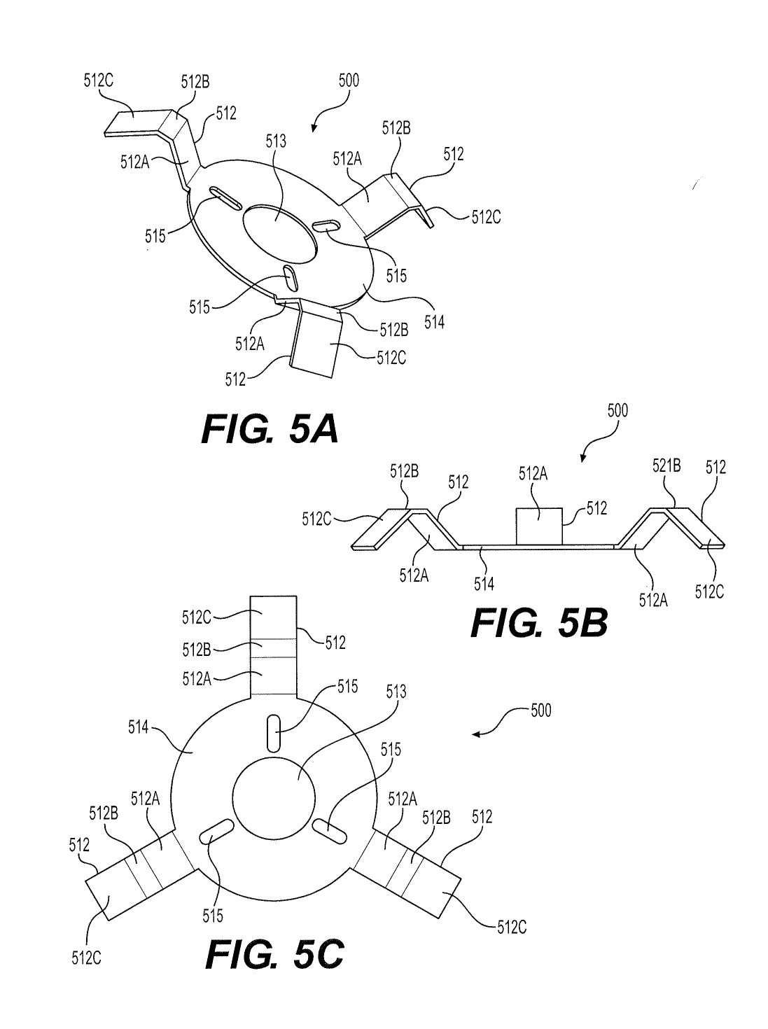

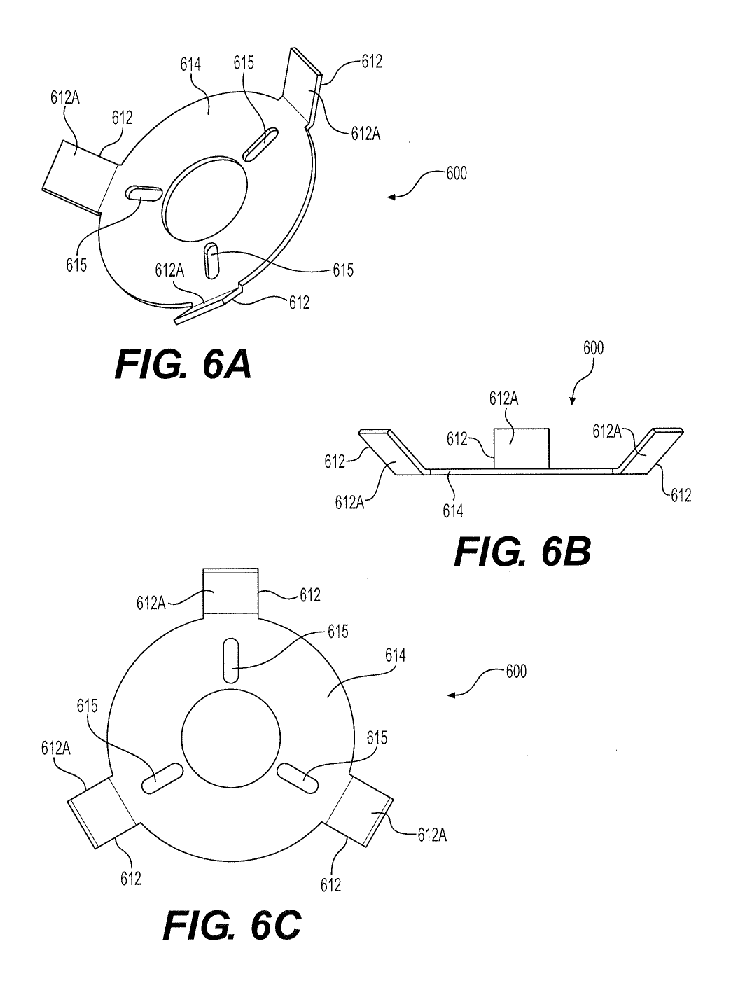

FIGS. 5A-5C illustrate a further embodiment of a color-coded element. FIG. 5A is a perspective view, FIG. 5B is a side view, and FIG. 6C is a bottom view. This embodiment of color-coded element 500 also has three wings 512, however, the wings 512 are formed somewhat differently from the wings of the previous embodiments.

Each of the wings 512 includes a generally upward extending portion 512A which extends generally upwardly from base plate 514, i.e., at an angle of 45° plus/minus several degrees. Extending generally flat from upward extending portion 512A, i.e., at an angle of approximately 45° plus/minus several degrees with respect to upward extending portion 512A, and generally parallel to base plate 514, is a flat portion 512B. Further, extending generally downwardly from flat portion 512B is downward extending portion 512C. Downward extending portion 512C extends generally downwardly from flat portion 512B, i.e., at an angle of 45° plus/minus several degrees with respect to flat portion 512B. Upward extending portion 512A and downward extending portion 512C extend at generally the same angle with respect to flat portion 512B. In this embodiment, the upward extending portion 512A and downward extending portion 512C have generally the same length. Thus, the bottom-most portion of downward extending portion 512C extends almost to the plane of the base plate 514.

The color-coded element 500 also has three slots 515 provided in the base plate 514. This embodiment of color-coded element 500 does not have radial cuts that extend from the aperture 513 of the color-coded element 500.

FIGS. 6A-6C illustrate a further embodiment of a color-coded element. FIG. 6A is a perspective view, FIG. 6B is a side view, and FIG. 6C is a bottom view. This embodiment of color-coded element 600 also has three wings 612, however, the wings 612 only include a generally upward extending portion 612A which extends generally upwardly from base plate 614, i.e., at an angle of 45° plus/minus several degrees. The color-coded element 600 also has three slots 615 provided in the base plate 614.

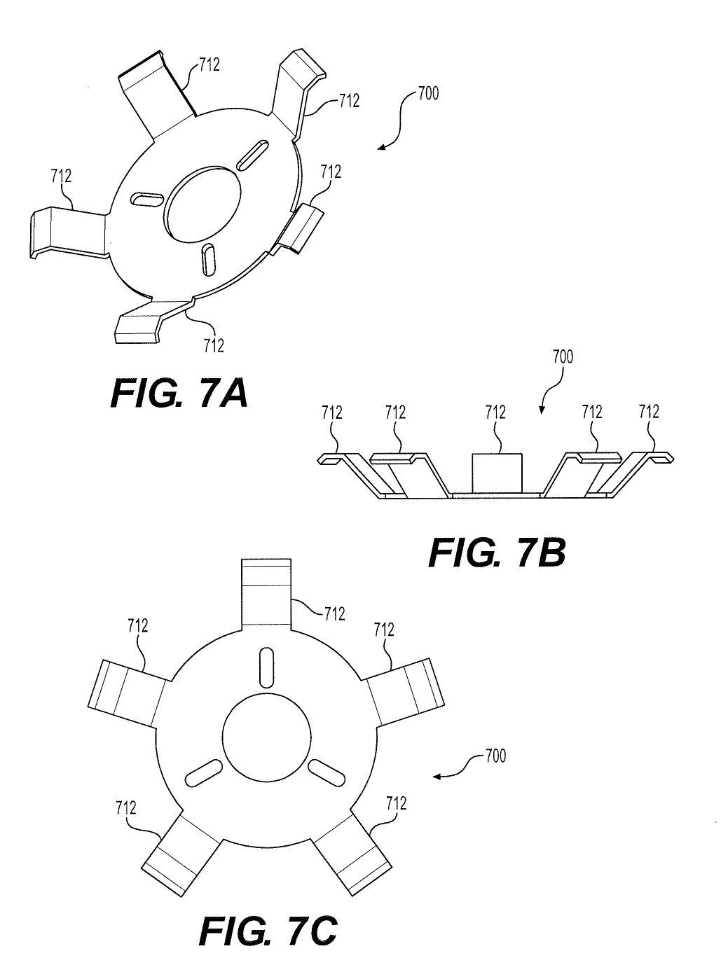

FIGS. 7A-7C illustrate a further embodiment of a color-coded element. FIG. 7A is a perspective view, FIG. 7B is a side view, and FIG. 7C is a bottom view. This embodiment of color-coded element 700 has five wings 712. The wings 712 are formed similarly to wings 312 of the embodiment of color-coded element 300.

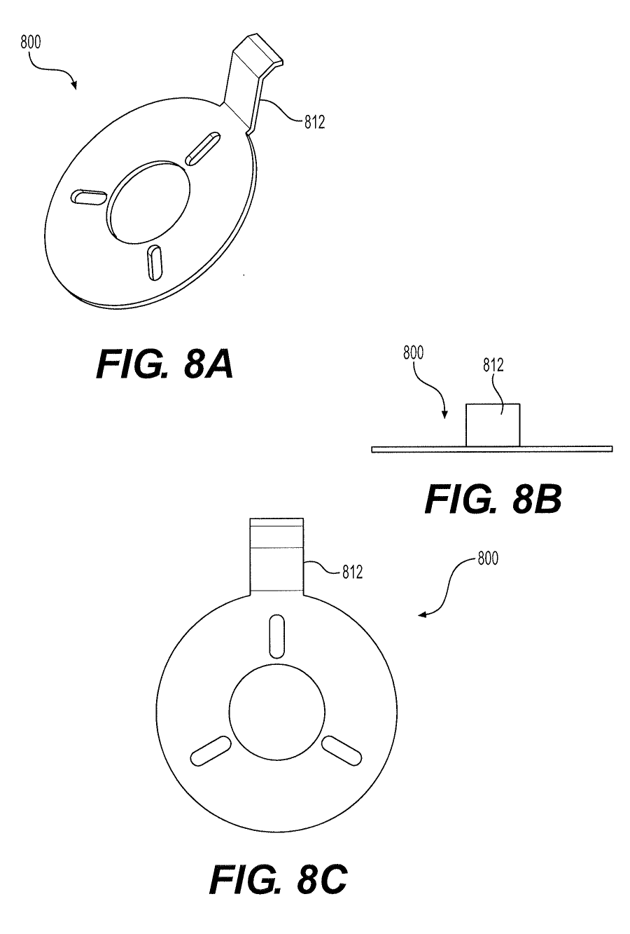

FIGS. 8A-8C illustrate a further embodiment of a color-coded element. FIG. 8A is a perspective view, FIG. 8B is a side view, and FIG. 8C is a bottom view. This embodiment of color-coded element 800 only has one wing 812. The wing 812 is also formed similarly to wings 312 of the embodiment of color-coded element 300.

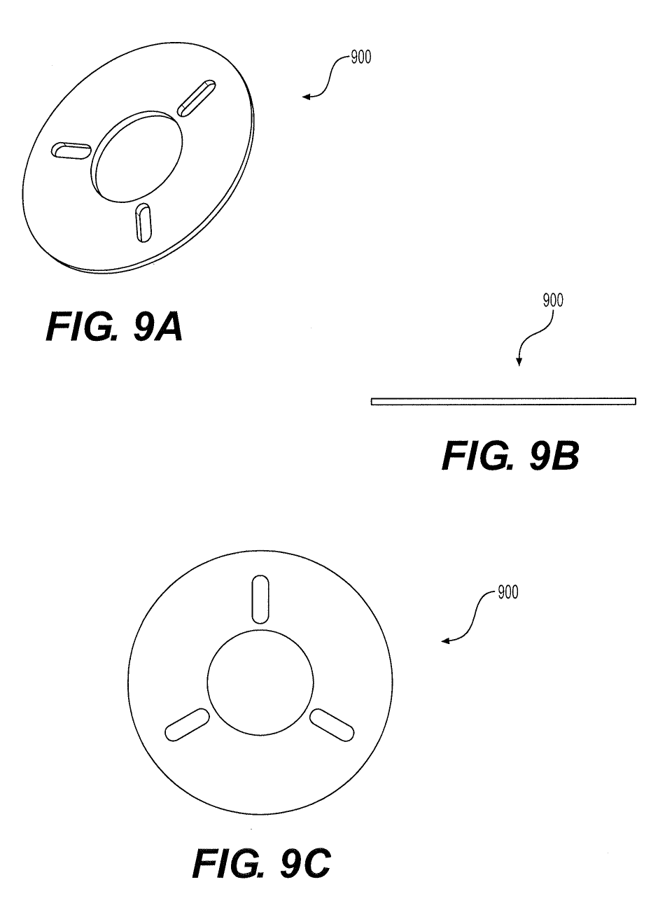

FIGS. 9A-9C illustrate an embodiment of the color-coded element as also shown in FIG. 1. FIG. 9A is a perspective view, FIG. 9B is a side view, and FIG. 9C is a bottom view. This embodiment of color-coded element 900 has no wings. The color-coded element 900 is a flat disk with slots and an aperture. The color-coded element may be assembled to the single point anchor and/or the sleeve by sticking the color-coded element on the single point anchor and/or sleeve like a sticker. Further, slots are not required, particularly with respect to this embodiment. The flat disk could be placed inside of the circumference formed by the nails.

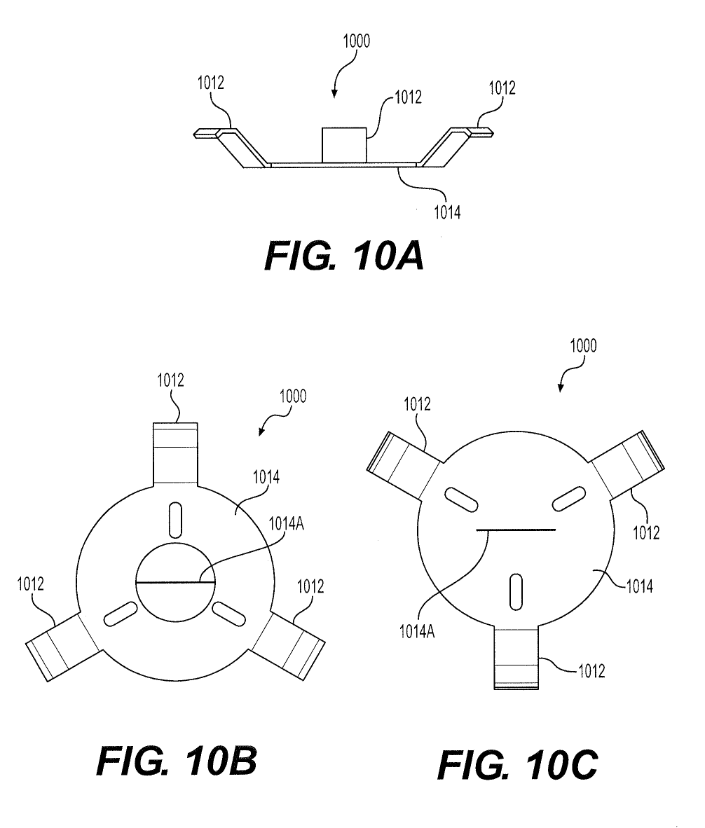

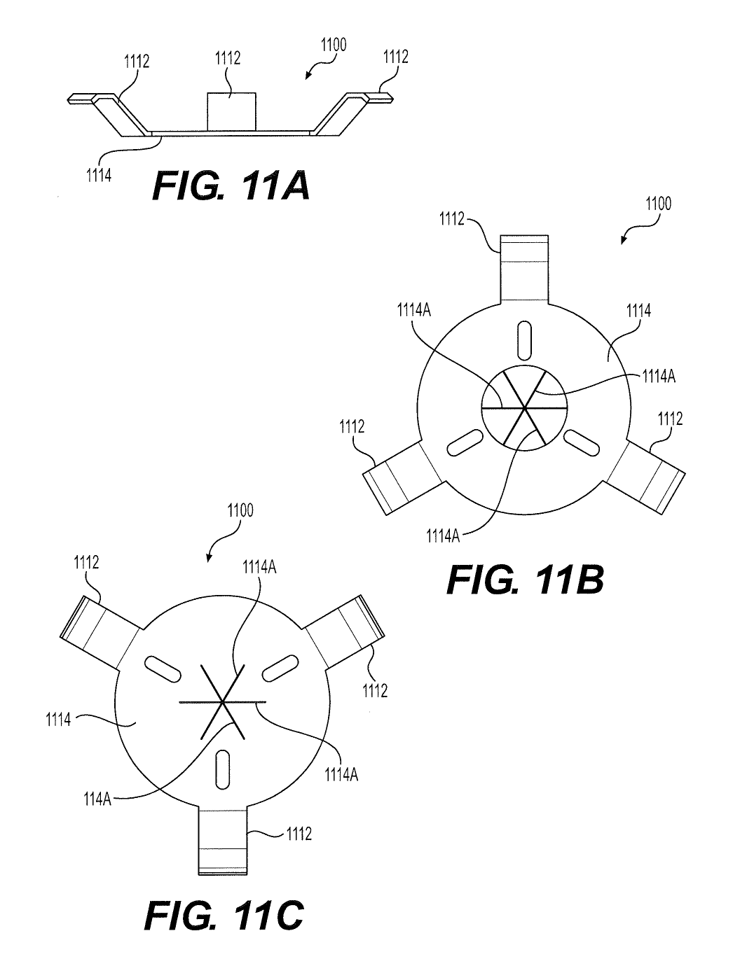

FIGS. 10A-10C and 11A-11C illustrate further embodiments of a color-coded element 1000 and 1100, respectively. FIGS. 10A and 11A are side views, FIGS. 10B and 11B are top views, and FIGS. 10C and 11C are bottom views. As can be seen, both embodiments include three wings 1012, 1112, respectively. The wings are formed similarly to wings 312 of the embodiment of color-coded element 300.

However, whereas the other embodiments of the color-coded elements have a central open aperture, the embodiments 1000 and 1100 do not include a central, completely open aperture. Rather, the color-coded elements of these embodiments are formed with a continuous membrane for base plates 1014, 1114. In the embodiment for color-coded element 1000, the membrane of base plate 1014 contains a slit (cut) 1014A, or “closed” opening, that may be penetrated by a threaded connector when threaded into the single point anchor.

The embodiment for color-coded element 1100 also includes a membrane for base plate 1114, however, the base plate 1114 contains three slits (cuts) 1114A that may be penetrated by a threaded connector when threaded into the single point anchor.

Thus, as can be understood, and as also discussed above, the present invention also provides a method for coding of an anchor point in a structure. In an embodiment, the method includes the steps of associating a coded element with a single point anchor, where the coded element includes an indicia that is indicative of a use of the single point anchor with a function. The single point anchor is disposed in the structure and the coded element is disposed on a surface of the structure.

The present invention also provides a method of identifying anchor points in a structure. In an embodiment, the method includes the steps of disposing a plurality of single point anchors in the structure, where each of the plurality of single point anchors is associated with a respective one of a plurality coded elements and where each of the plurality of coded elements includes a respective indicia that is indicative of a use of the associated single point anchor with a function.

As also discussed above, the method of the present invention includes assembling a coded element to a single point anchor. The coded element is assembled to the single point anchor before the single point anchor is nailed into the wood form. It can be pre-assembled before it is sold as an anchoring apparatus or the coded element can be sold as a separate item and then assembled to the single point anchor and sleeve on the job site. The coded element can be assembled to the single point anchor and the sleeve via the nails of the sleeve that are associated with both the single point anchor and the coded element. The coded element can also be assembled to the single point anchor and/or the sleeve by using an adhesive for attaching the coded element to the single point anchor and/or the sleeve. Additionally, the central aperture of the coded element can be disposed around the cylindrical body of the single point anchor, which cylindrical body has the internal cavity that is able to receive a threaded connector within the cavity. However, the present invention is not limited to these ways of assembling the coded element to the single point anchor and/or the sleeve. Further, it is not required that the coded element be directly attached to the single point anchor. All that is required is that the coded element be associated with the single point anchor such that the coded element is indicative of a use of the single point anchor with a function.

To further describe the installation process of the anchor apparatus, the coded element is installed together with the single point anchor, and sleeve, through the hammering process into the wood form. The coded element will stay in place between the single point anchor and the wood form during the pouring and curing of the concrete. The coded element stays in place when the wood form is removed and the nails are broken off, if nails are used. Thus, the coded element provides for a visual coding of the single point anchor when the wood form is removed in terms of the functional application for the single point anchor.

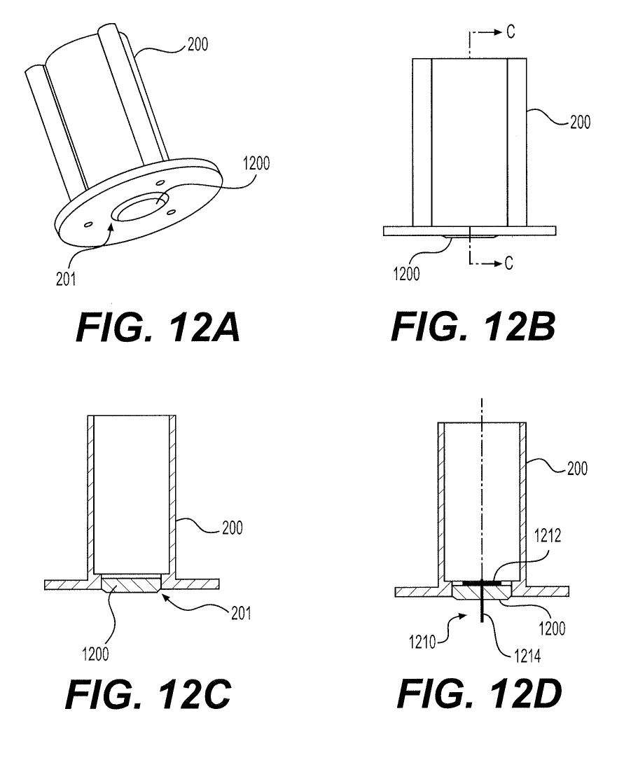

FIGS. 12A-12D illustrate a further embodiment of a color-coded element 1200 as used with a sleeve 200 of the anchor apparatus. As discussed above, the present invention is not limited to the above described ways of assembling the coded element to the single point anchor and/or the sleeve. FIGS. 12A-12D, and FIGS. 13-16 which will be discussed below, disclose additional embodiments for a coded element, and thus, additional ways of assembling the coded element to the sleeve of the anchor apparatus.

As can be seen in FIGS. 12A-12C, the color-coded element 1200 is a plug that can be disposed in the aperture 201 defined by the lowest-most portion of the sleeve 200, through which aperture the threaded connector is inserted into the single point anchor. If a sleeve is not used, the plug can be disposed in the aperture defined by the bottom-most portion of the single point anchor, through which aperture the threaded connector is also inserted for mounting in the single point anchor.

The plug has a diameter that corresponds to the diameter of the aperture of the sleeve such that the plug can be inserted into the sleeve, but yet, retained in the sleeve by frictional engagement with the sleeve. The bottom-most portion of the plug can extend slightly below the bottom-most portion of the sleeve so that the color of the plug remains easily visible after insertion of the plug into the sleeve and so that the plug can be easily gripped by the hand of a contractor, for example, or a tool, such as pliers, to remove the plug after the concrete is poured, the wood form is removed, and the single point anchor is identified by the contractor for its use.

The plug can be made out of any of a variety of materials, such as plastic or foam.

Additionally, as can be seen in FIG. 12D, the plug can include a tab element 1210. The tab element 1210 can be used to assist in removal of the plug from the sleeve. In this embodiment, the tab element 1210 is basically T-shaped where the horizontal portion 1212 is disposed above the plug and the vertical portion 1214 extends through the plug and beyond the lowest-most portion of the plug. As can be understood, a person's hand or a tool can be used to pull on the lowest-most portion of the vertical portion 1214, which extends beyond the lowest-most portion of the plug, to remove the plug from the sleeve.

Whereas the illustrated tab element has a T-shaped structure and is disposed through the plug, the present invention is not limited to such a physical configuration. All that is required is that the tab element be attached to the plug and be engagable by a hand or a tool. As such, the tab element could be adhered to the lowest-most portion of the plug with an adhesive, for example, or could be integrally formed with the plug, such as being molded in one piece with the plug. Additional physical configurations can also be utilized in accordance with the principles of the present invention.

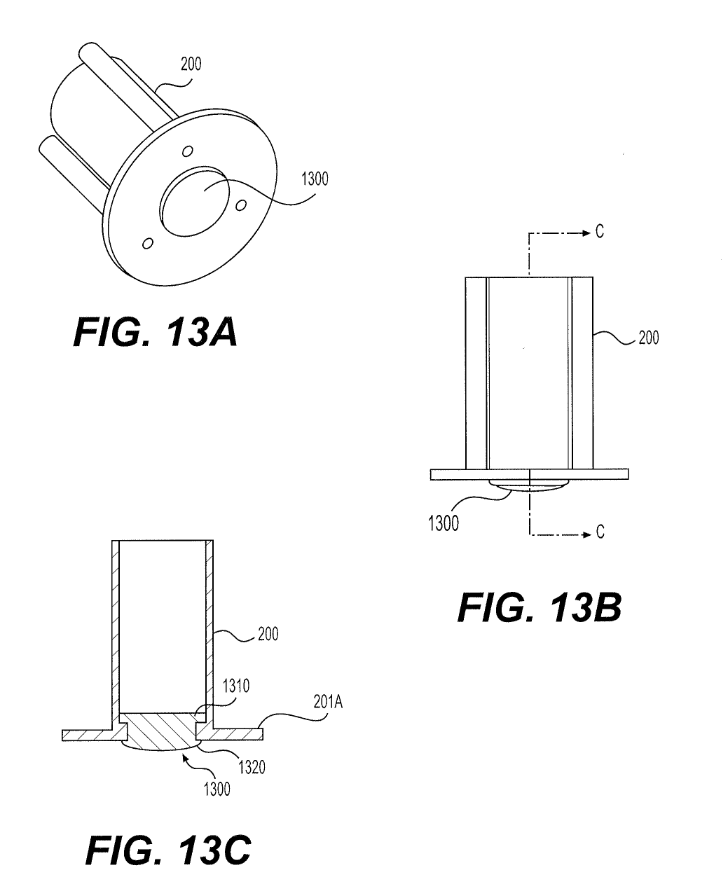

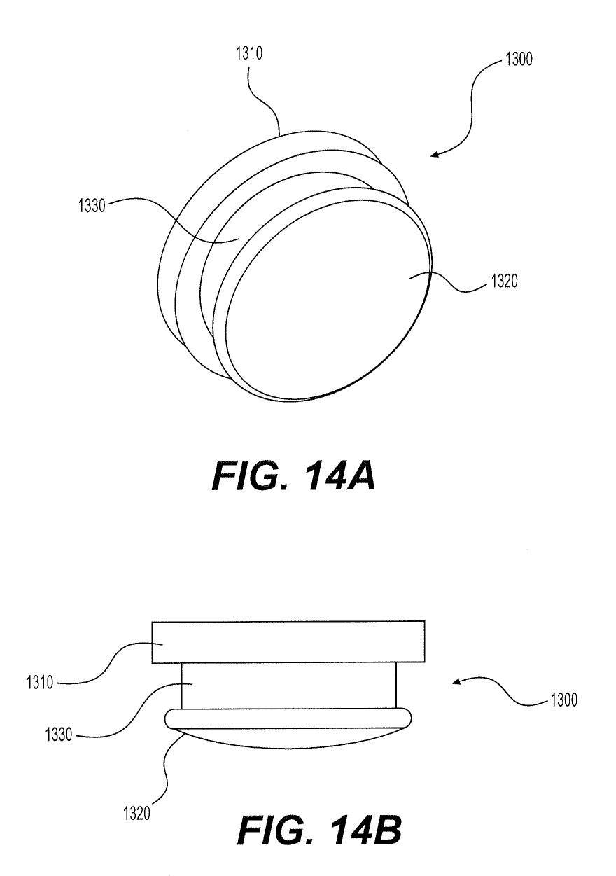

FIGS. 13A-13C and 14A-14B illustrate a further embodiment of a color-coded element 1300, as used with a sleeve 200 of the anchor apparatus in this illustrated embodiment. In discussing this further embodiment, and the other embodiments below, generally only the differences in the embodiments will be discussed.

As can be seen in FIGS. 13A-13C, the color-coded element 1300 is also a plug that can be disposed in the aperture defined by the lowest-most portion of the sleeve 200.

In this embodiment, the plug has an upper portion 1310 and a lower portion 1320. Between the upper portion 1310 and the lower portion 1320 a groove 1330 is defined by the upper and lower portions. When the plug is inserted into the sleeve 200, the upper portion 1310 is disposed above a portion of the ledge 201A of the sleeve, the lower portion 1320 is disposed below this portion of the ledge 201A, and the inner-most portion of ledge 201A is disposed in groove 1330 of the plug. Thus, the plug can be retained within the sleeve with these configurations of the plug and the sleeve. Of course, the plug is made of a material which is pliable enough such that the upper portion 1310 can be deformed for insertion and removal with respect to ledge 201A.

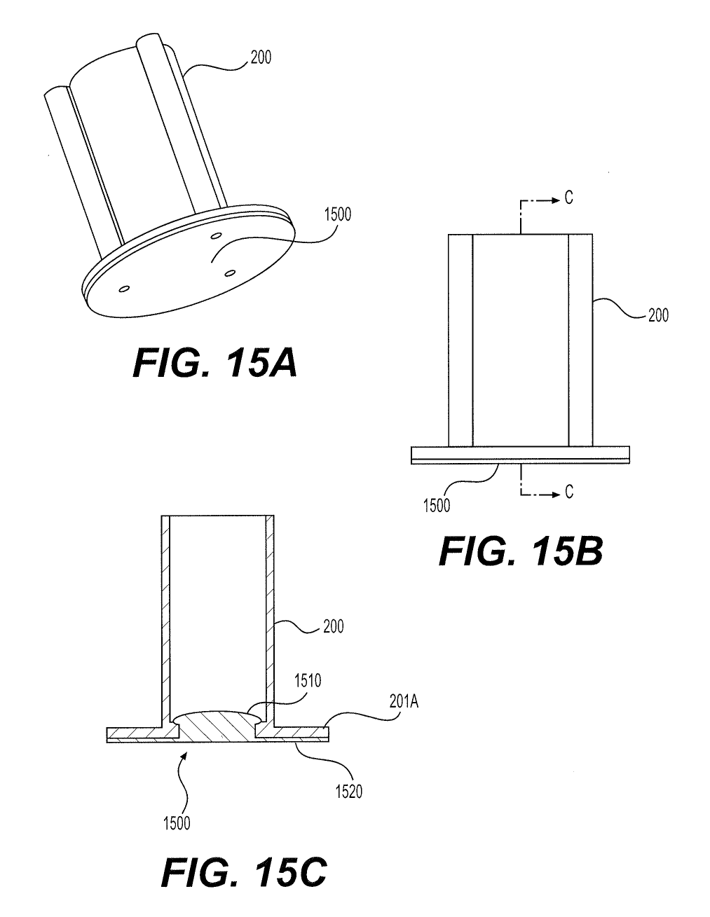

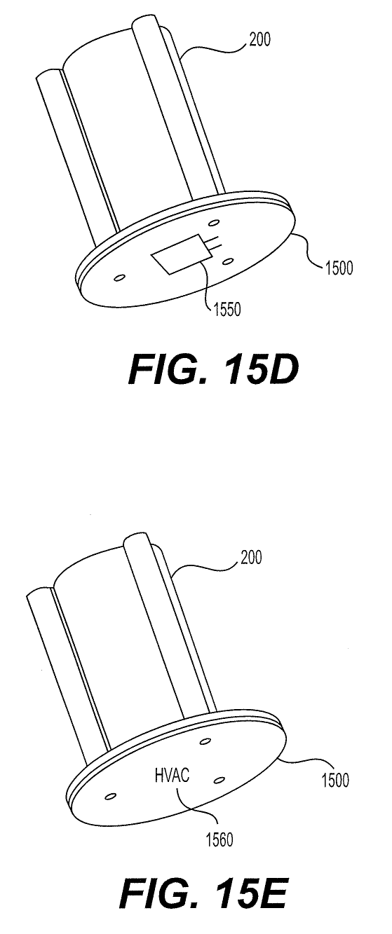

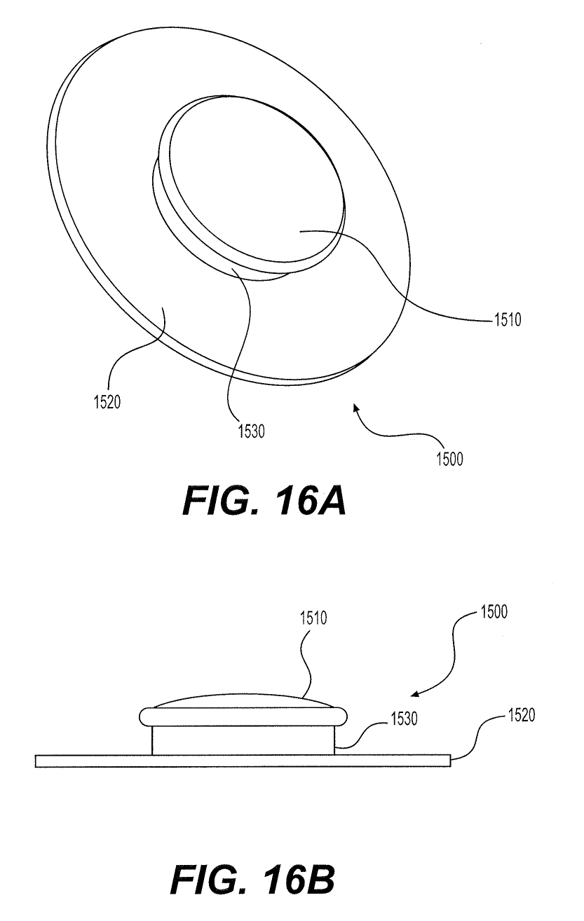

As can be seen in FIGS. 15A-15C and 16A-16B, the color-coded element 1500 is again a plug that can be disposed in the aperture defined by the lowest-most portion of the sleeve 200.

In this embodiment, the plug also has an upper portion 1510 and a lower portion 1520, between which upper portion 1510 and lower portion 1520 a groove 1530 is also defined. As with the previous embodiment, when the plug is inserted into the sleeve 200, the upper portion 1510 is disposed above a portion of the ledge 201A of the sleeve, the lower portion 1520 is disposed below this portion of the ledge 201A, and the inner-most portion of ledge 201A is disposed in groove 1530 of the plug.

In this embodiment, the upper portion 1510 has a curved top surface and the lower portion 1520 is an elongated, flat structure that extends radially outward beyond the upper portion. The lower portion 1520 engages with at least a substantial length, e.g., 25% of the length, of the lower surface of ledge 201A of sleeve 200. The lower portion 1520 can engage with the entire length of the lower surface of the ledge 201A. This length of the lower portion 1520 can provide for even greater visibility of the color code of the color-coded element.

FIGS. 15D-15E further illustrate the embodiment of FIGS. 15A-15C and 16A-16B, however, as discussed previously, instead of the coded element 1500 being a color-coded element, coded element 1500 includes an indicia that is not a color. In FIG. 15D, the indicia 1550 is a graphic of an electrical plug that is indicative of a use of the single point anchor with an electrical function. In FIG. 15E, the indicia 1560 is text of HVAC that is indicative of a use of the single point anchor with a heating, ventilation, and air conditioning function.

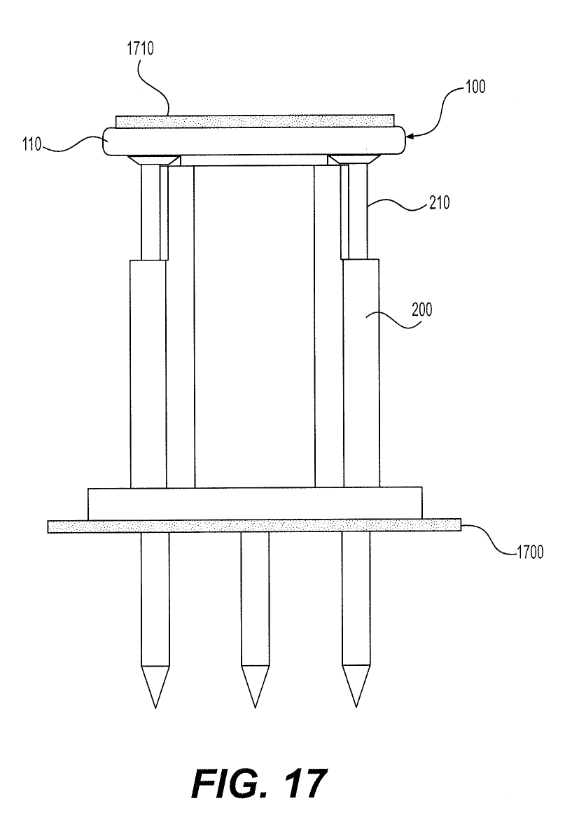

FIG. 17 illustrates an embodiment of the anchor apparatus with an additional color-coded element. The anchor apparatus includes the single point anchor 100, the sleeve 200 with nails 210, and a color-coded element 1700 which is disposed and used as in the prior embodiments. However, in this embodiment, a second color-coded element 1710 is used. In an embodiment, the second color-coded element 1710 is disposed on top of the single point anchor striking surface 110. The second color-coded element 1710 has the same color coding, i.e., includes the same color, as the color-coded element 1700. Thus, the second color-coded element 1710 and. the color-coded element 1700 have the same color and are disposed on opposite ends of the single point anchor 100.

Thus, providing the same color coding on both the upper and lower ends of the anchor apparatus can provide advantages. For example, after the anchor apparatus is nailed into the wood form, but before the concrete is poured, the function of the anchor apparatus can still be easily determined by viewing the upper second color-coded element. As such, the layout of the installed anchor apparatuses in the wood form can be verified before the concrete is poured since the colors of the various installed anchor apparatuses can be easily seen on the top end of the anchor apparatuses.

However, the present invention is not limited to any particular location for disposing a second color-coded element. Alternatively, the second color-coded element can be a ring(s) that is/are disposed on one of the nails. Further yet, the second color-coded element can be disposed on a top surface of the base plate of the sleeve.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus for coding of an anchor point, comprising:
a single point anchor; and
a coded element associated with the single point anchor, wherein the coded element includes an indicia that is indicative of a use of the single point anchor with a function.

2. The apparatus according to claim 1, wherein the function is an electrical system or a plumbing system or a mechanical system.

3. The apparatus according to claim 1 further comprising a sleeve, wherein the sleeve is disposed around the single point anchor, wherein the sleeve includes a further indicia, and wherein the further indicia is indicative of a size of the single point anchor.

4. The apparatus according to claim 3 further comprising a plurality of nails, wherein the plurality of nails are disposed in the sleeve.

5. The apparatus according to claim 1, wherein the coded element is a disk, wherein the disk includes an aperture, and wherein the aperture of the disk aligns with an aperture of the single point anchor.

6. The apparatus according to claim 1, wherein the coded element is a membrane and wherein the membrane includes a slit.

7. The apparatus according to claim 1, wherein the coded element has a wing that extends from an outer circumference of the coded element and wherein the wing extends upward from the outer circumference toward a head of the single point anchor.

8. The apparatus according to claim 4, wherein the coded element has a plurality of slots and wherein each of the plurality of nails is disposed through a respective one of the plurality of slots.

9. The apparatus according to claim 5, wherein the disk includes a radial cut that extends from the aperture.

10. The apparatus according to claim 1 further comprising a sleeve, wherein the sleeve is disposed around the single point anchor, wherein the coded element is a plug, and wherein the plug is insertable into an aperture of the sleeve.

11. The apparatus according to claim 10, wherein the plug includes a tab element.

12. The apparatus according to claim 10, wherein the plug includes an upper portion, a lower portion, and a groove defined between the upper portion and the lower portion.

13. The apparatus according to claim 1 further comprising a second coded element associated with the single point anchor, wherein the second coded element includes the indicia of the coded element.

14. The apparatus according to claim 1, wherein the indicia is a color or a graphic or text.

15. The apparatus according to claim 1, wherein the coded element is a color-coded element.

16. The apparatus according to claim 1, wherein the indicia contains multiple colors.

17. The apparatus according to claim 13, wherein the second coded element and the coded element are disposed on opposite ends of the single point anchor.

18. A building structure, comprising:
a structure;
a single point anchor; and
a coded element associated with the single point anchor, wherein the coded element includes an indicia that is indicative of a use of the single point anchor with a function;
wherein the single point anchor and the coded element are disposed on the structure.

19. The building structure according to claim 18, wherein the structure is a poured concrete structure, wherein the single point anchor is disposed within the poured concrete structure, and wherein the coded element is disposed on a surface of the poured concrete structure.

20. The building structure according to claim 18, wherein the function is an electrical system or a plumbing system or a mechanical system.

21. The building structure according to claim 18, further comprising a sleeve, wherein the sleeve is disposed around the single point anchor, wherein the sleeve includes a further indicia, and wherein the further indicia is indicative of a size of the single point anchor.

22. The building structure according to claim 18, wherein a bottom surface of the coded element is disposed below a bottom surface of the structure.

23. The building structure according to claim 18, wherein the indicia is a color or a graphic or text.

24. The building structure according to claim 18, wherein the coded element is a color-coded element.

25. The building structure according to claim 18, wherein the indicia contains multiple colors.

26. A method for coding of an anchor point in a structure, comprising the steps of:
associating a coded element with a single point anchor, wherein the coded element includes an indicia that is indicative of a use of the single point anchor with a function; and
disposing the single point anchor and the coded element in the structure.

27. The method according to claim 26, wherein the function is an electrical system or a plumbing system or a mechanical system.

28. The method according to claim 26, further comprising a sleeve, wherein the sleeve is disposed around the single point anchor, wherein the sleeve includes a further indicia, and wherein the further indicia is indicative of a size of the single point anchor.

29. The method according to claim 26, wherein the indicia is a color or a graphic or text.

30. The method according to claim 26, wherein the coded element is a color-coded element.

31. The method according to claim 26, wherein the indicia contains multiple colors.

32. A method of identifying anchor points in a structure, comprising the steps of:
disposing a plurality of single point anchors in the structure:
wherein each of the plurality of single point anchors is associated with a respective one of a plurality of coded elements and wherein each of the plurality of coded elements includes a respective indicia that is indicative of a use of the associated single point anchor with a function.

33. The method according to claim 32, wherein the function is an electrical system or a plumbing system or a mechanical system.

34. The method according to claim 32, wherein a respective sleeve is disposed around each of the plurality of single point anchors, wherein the respective sleeve includes a further indicia, and wherein the further indicia is indicative of a size of the respective single point anchor.

35. The method according to claim 32, wherein the respective indicia is a color or a graphic or text.

36. The method according to claim 32, wherein the plurality of coded elements are color-coded elements.

37. The method according to claim 32, wherein the respective indicia contain multiple colors.
